(19) United States
(12) Patent Application Publication
(10) Pub. No.: US 2009/0115218 A1
(43) Pub. Date: May 7, 2009

(54) Automobile sunshade for front passenger

(76) Inventor: Chau Huu-Quynh Nguyen, Ho Chi Minh City (VN)

Correspondence Address: PHUNG LAW FIRM, P.C., 10623 BELLAIRE BLVD, SUITE C-130, HOUSTON, TX, 77072-5242, US

(21) Appl. No.: 12/151,930

(22) Filed: May 8, 2008

(30) Foreign Application Priority Data
Nov. 2, 2007 (VN) 2-2007-00179

(51) Int. Cl. B60J 3/02

(52) U.S. Cl. 296/97.7

(57) ABSTRACT

A device and method for blocking sunlight from shining on the front passenger's side of an automobile. The invention uses a shade made of a sheet of material capable of blocking sunlight. The shade is mounted to the dashboard of the automobile and extends towards the back support of the front passenger seat. The shade blocks sunlight from shining on the general area of the front passenger seat. The shade can extend and retract manually or automatically from the dashboard.

### CROSS-REFERENCE TO RELATED APPLICATIONS

This application claims the benefit of foreign application number 2-2007-00179, filed on Nov. 2, 2007, in the National Office of Intellectual Property of Vietnam. The contents of such application are hereby incorporated by reference.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION BY REFERENCE OF MATERIAL SUBMITTED ON A COMPACT DISC

Not applicable

### BACKGROUND OF THE INVENTION

1. Field of the Invention

This invention generally relates to a sunshade for a front passenger in an automobile.

2. Background Art

Automobile sunshades are used to block sunlight. Prior art automobile sunshades are placed in the interior cabin adjacent to the glass of windows. Sunshades are often applied on parked cars on a sunny day. Sunshades are also used on cars when they are being driven. The use of sunshades helps to reduce heat inside the car, allowing passengers to be more comfortable. It also reduces the use of air-conditioning to cool the interior, thereby saving fuel and reducing strain on the car's engine.

### BRIEF SUMMARY OF THE INVENTION

The present invention is a device and method for blocking sunlight from shining on the front passenger's side of an automobile. One embodiment of the invention is a sunshade device for a front passenger of an automobile that has a dashboard and a front passenger seat. The sunshade device includes a housing mounted onto the dashboard of the automobile in front of the front passenger seat. The housing has a front opening facing the front passenger. Two telescoping antenna rods are mounted to the housing. A shade is attached to the telescoping antenna rods. The shade is made of a sheet attached between two tubes. Each telescoping antenna rod slides into one of the tubes. The ends of the tubes are fasten to the telescoping antenna rods. The shade may be made of any flexible material capable of blocking sunlight. When sunshade is desired, the telescoping antenna rods extend out of the front opening of the housing towards the body of the passenger. The flexible shade is positioned over the passenger's body, blocking sunlight from shining on the passenger's body. When use of the sunshade is no longer desired, the telescoping antenna rods and the shade retract back in to the housing.

In another embodiment of the present invention, the sunshade device includes a sheet of material capable of blocking sunlight. The sheet is mounted to the dashboard of the automobile and extends towards the back support of the front passenger seat, blocking sunlight from shining on the general area of the front passenger seat.

Another embodiment of the present invention is a method for shading a front passenger of an automobile from sunlight. The automobile has a retractable shade mounted to the dashboard in front of the front passenger. The shade is in an initial retracted position. The steps of the method includes extending the shade towards the body of the front passenger to block sunlight from the front passenger's body, and retracting the shade towards the dashboard after use.

### BRIEF DESCRIPTION OF THE SEVERAL VIEWS OF THE DRAWINGS

FIG. 1 shows a perspective view of how an embodiment of the present invention is used.

FIG. 2 shows some of the components inside an embodiment of the present invention.

FIG. 3 shows a shade for an embodiment of the present invention.

FIG. 4 shows an embodiment to the present invention where antenna rods slide into the tube structures of a shade.

FIG. 5 shows an embodiment of the present invention where a spring door is added to cover the front opening of the housing.

FIG. 6 shows an embodiment of the present invention where a door opening mechanism is employed.

FIG. 7 shows an embodiment of the present invention where the sunshade device is mounted under the glove compartment of the dashboard.

FIG. 8 shows an embodiment of the present invention where the sunshade device is mounted between the glove compartment and the airbag compartment of the dashboard.

FIG. 9 shows an embodiment of the present invention where the sunshade device is mounted above the airbag compartment of the dashboard.

Like elements in the various figures are denoted by like reference numerals for consistency.

### DETAILED DESCRIPTION OF THE INVENTION

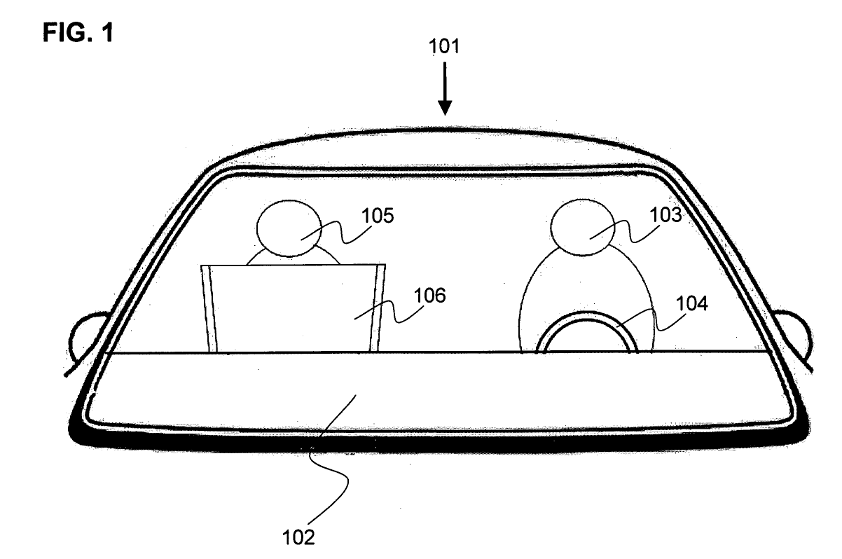

The present invention is a device and method for blocking sunlight from shining on the front passenger's side of an automobile. FIG. 1 shows a perspective view of how an embodiment of the present invention is used. The interior of an automobile 101 as viewed through the windshield. The dashboard 102 is at the front of the interior. The driver 103 sits behind the steering wheel 104. The passenger 105 sits next to the driver 103. The sunshade 106 is mounted on the dashboard 102 in front of the passenger. The sunshade 106 extends from the dashboard 102 towards the passenger's neck, shading the passenger 105 from the neck down.

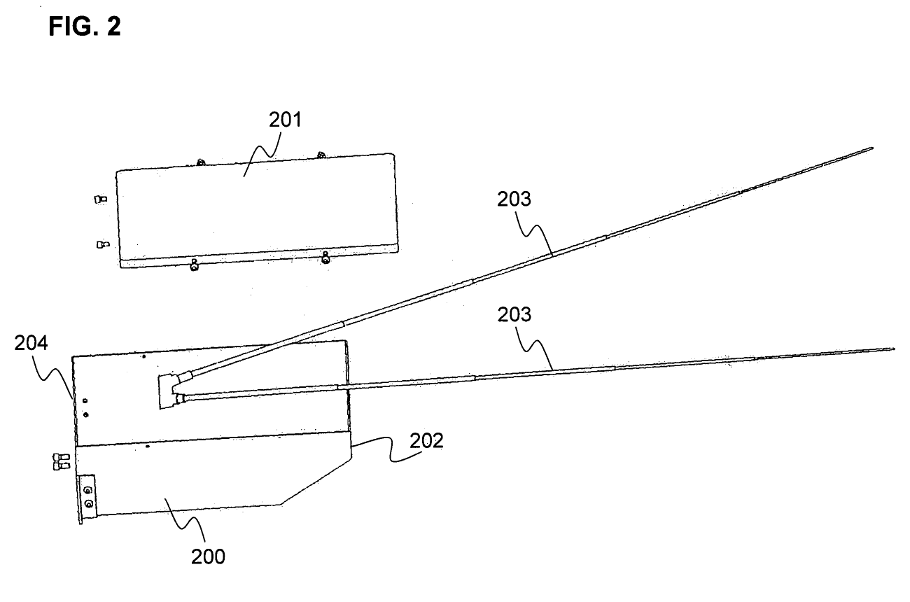

FIG. 2 shows some of the components inside an embodiment of the present invention. Various parts are contained inside a rectangular housing 200 with a detachable top cover 201 and a front opening 202. The top cover 201 is attached to the housing using screws. The housing 200 is mounted onto the dashboard of the automobile using screws. The housing 200 can be mounted on top of, under, or inside of the dashboard 102. The housing 200 is positioned in front of the front passenger's seat. Two telescoping antenna rods 203 are mounted to the back wall 204 of the housing 200. The mounted end of the antenna rod 203 contains a joint (not shown) which allows the antenna rod 203 to be bent at different angles. The antenna rods 203 can extend or retract manually or automatically by electrical means. A person having ordinary skill in the art would be able to adapt a power antenna mechanism to electrically extend and retract the antenna rods 203. In one embodiment, a sensor (not shown) is employed to monitor vibrations on the automobile while it is being driven. When there is excessive vibration, the sensor will cause the antenna rods 203 to automatically retract.

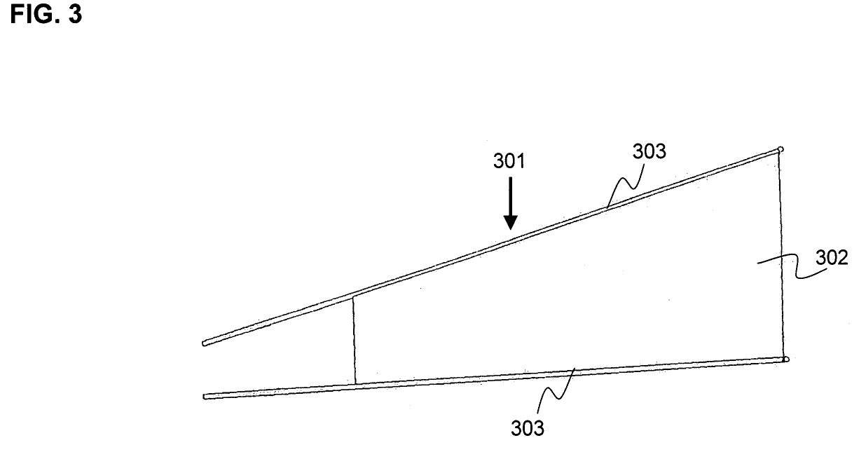

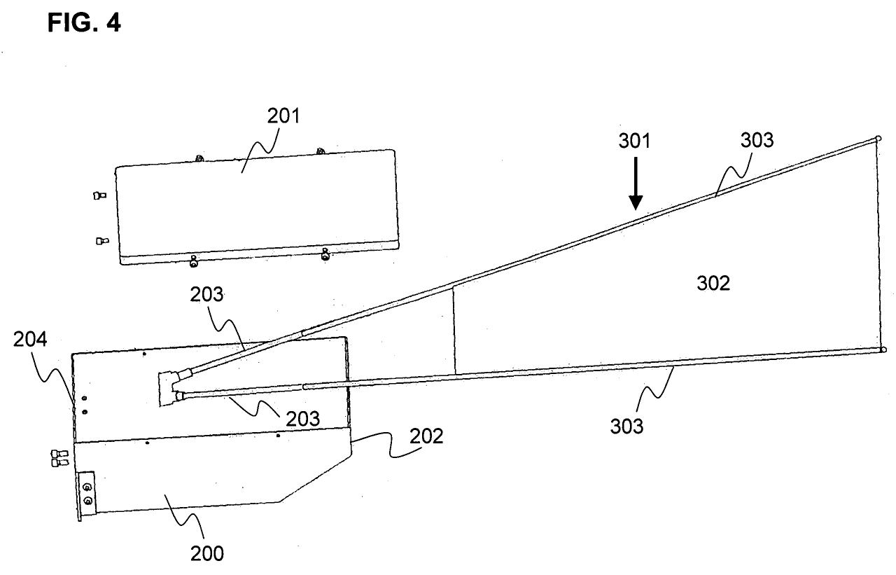

FIG. 3 shows a shade 301 for an embodiment of the present invention. The shade 301 is composed of a trapezoid-shaped sheet structure 302 attached between two tube structures 303. In one embodiment, the entire shade 301 is made of cloth. However, the shade 301 can be made of any flexible material capable of blocking sunlight, for example paper, plastic, rubber, etc. The antenna rods 203 slide into the tube structures 303 of the shade 301 and each end of the tube structure are fasten on to the antenna rods 203 as depicted in FIG. 4.

When sunshade is desired, the automobile passenger can extend the antenna rods 203 manually or automatically by electrical means. The shade 301 will extend from the front opening 202 of the housing 200 towards the body of the passenger. The shade 301 is positioning over the passenger's body blocking sunlight from shining on the passenger's body. The length of the antenna rods 203 and the horizontal angle of the shade 301 can be adjusted. For example, the shade 301 can be adjust to an angle that covers the passenger from the neck down, or the shade 301 can be adjusted to cover the passenger from the waist down. The shade 301 can also be adjusted to according to the height of the passenger. When use of the sunshade is no longer desired, the car passenger can retract the antenna rods 203 manually or automatically by electrical means. The shade 301 will retreat back into the housing 200.

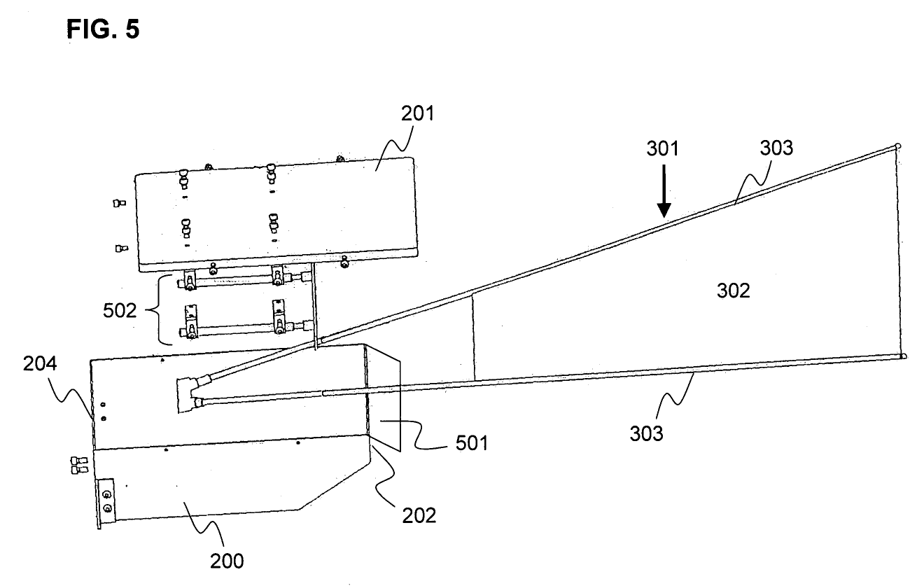

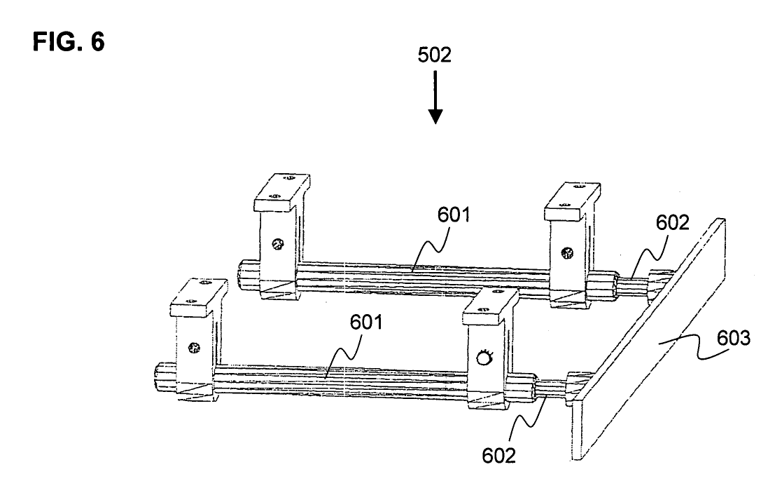

In another embodiment, an automatic door is placed on the front wall of the housing. The automatic door will open when sunshade is desired to allow the shade to extend from the housing. The automatic door will close when the sunshade is no long in use, after the shade retracts back into the housing. One embodiment of the automatic door employs a spring door 501 to cover the front opening 202 of the housing 200 as shown in FIG. 5. A door-opening mechanism 502 is mounted to the top cover 201. The door-opening mechanism is shown in greater detail in FIG. 6. Two cylinders 601 are mounted to the top cover 201. An inner rod 602 protrudes from each cylinder 601. The two inner rods are attached to a horizontal bar 603. A person having ordinary skill in the arts can extend and retract the inner rods 602 from the cylinders 601 automatically by electrical means. When sunshade is desired, the inner rods 602 are activated to extend from the cylinders 601. The horizontal bar 603 pushes the spring door open, allowing the antenna rods 203 and the shade 301 to extend outside of the housing 200. When sunshade is no longer desired, the antenna rods 203 and the shade 301 retreat back into the housing 200. The inner rods 602 retract back into the cylinder 601 and the spring door to the housing 200 closes.

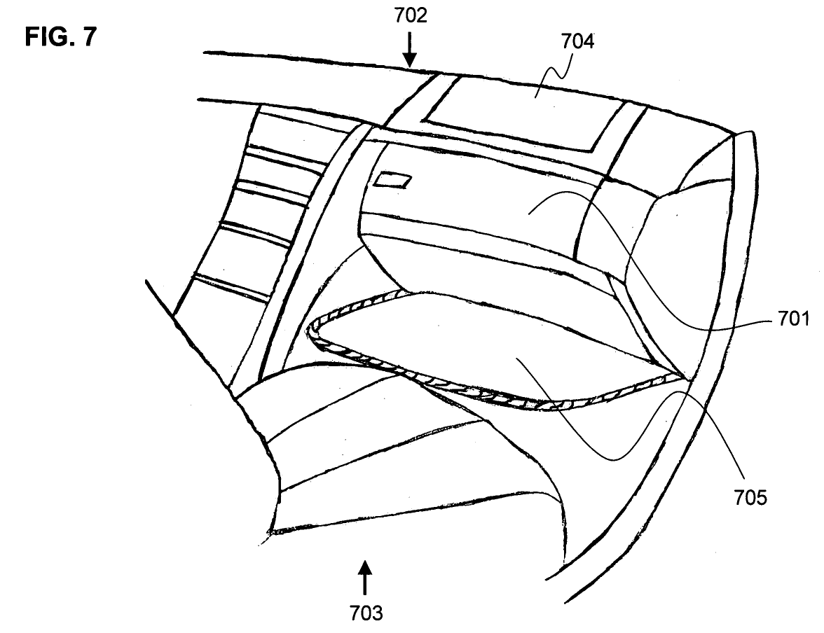

In another embodiment, the sunshade device is mounted below the glove compartment 701 of the automobile's dashboard 702 as shown in FIG. 7. Typically, the dashboard 702 area in front of the front passenger seat 703 has an airbag compartment 704 and a glove compartment 701. The retractable shade 705 extends from the dashboard 702 towards the front passenger seat 703. The shade 705 is made of a sheet of material capable of blocking sunlight. In one embodiment, the shade 705 is made of a sheet of flexible material, such as cloth, that is stretched and attached to the inside of a wired ring. The shade can extend and retract from the dashboard area manually or automatically by electrical means.

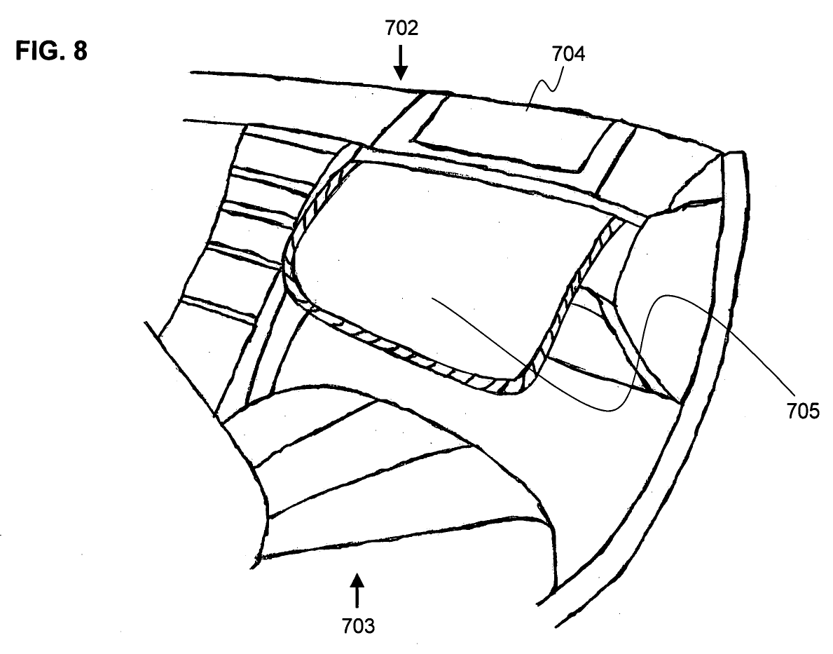

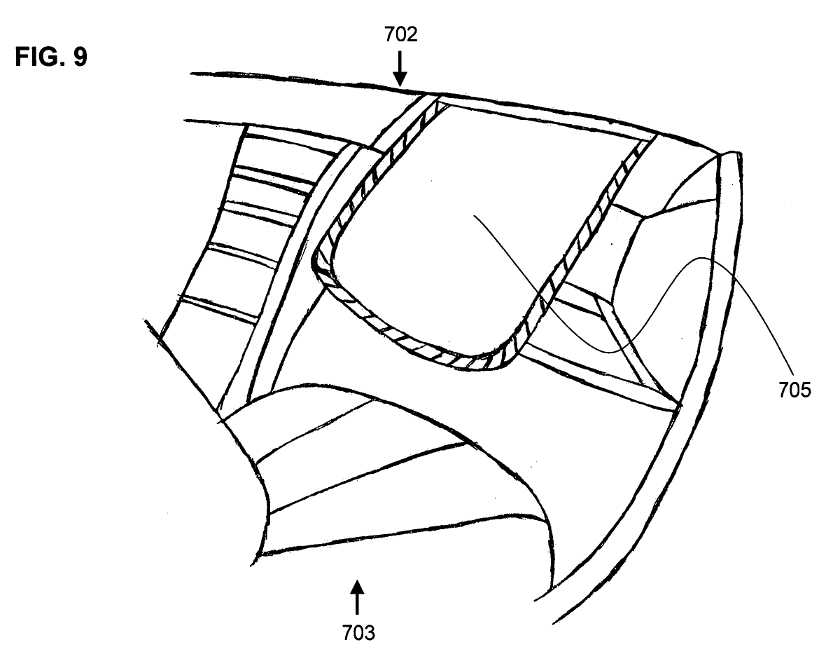

In yet another embodiment, the sunshade device is mounted between the glove compartment 701 and the airbag compartment as shown in FIG. 8. In yet another embodiment, the sunshade device is mounted above the airbag compartment 704 as shown in FIG. 9.

In other embodiments, the sunshade device is portable and can be easily mounted on and dismounted from a vehicle. In one embodiment, the portable sunshade device is mounted on top of the dashboard. In another embodiment, the portable sunshade device is mounted in the glove compartment. In yet another embodiment, the portable sunshade device is mounted below the glove compartment.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention. Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A sunshade device for a front passenger of an automobile; the automobile comprising a dashboard and a front passenger seat; the sunshade device comprising:
a housing mounted onto the dashboard of the automobile in front of the front passenger seat, wherein the housing has a front opening;
two telescoping antenna rods mounted to the housing,
a shade comprising a sheet attached between two tubes; wherein:
each telescoping antenna rod slides into one of the tubes;
the ends of the tubes are fasten to the telescoping antenna rods; and
the shade is made of flexible material capable of blocking sunlight;
whereby when sunshade is desired, the telescoping antenna rods extend out of the front opening of the housing towards the body of the passenger, and the flexible shade is positioned over the passenger's body, blocking sunlight from shining on the passenger's body; and when use of the sunshade is no longer desired, the telescoping antenna rods and the shade retract back in to the housing.

2. The sunshade device of claim 1, wherein the two telescoping antenna rods are mounted to the back wall of the housing.

3. The sunshade device of claim 2, wherein the shade is made of flexible material capable of blocking sunlight selected from the group consisting of cloth, paper, plastic, and rubber.

4. The sunshade device of claim 1, further comprising a means for extending and retracting the telescoping antenna rods automatically.

5. The sunshade device of claim 4, further comprising a sensor to monitor vibrations on the automobile, wherein when the sensor senses excessive vibration, the sensor causes the telescoping antenna rods to retract.

6. The sunshade device of claim 1, wherein the mounted end of the telescoping antenna rods further comprising a bendable joint allowing the angle of shade to be adjustable.

7. The sunshade device of claim 1, wherein the length of the telescoping antenna rods are adjustable.

8. The sunshade device of claim 1, wherein the housing further comprises a door to the front opening.

9. The sunshade device of claim 8, further comprising a means for opening and closing the door automatically.

10. The sunshade device of claim 1, wherein the housing is mounted onto the dashboard at a vertical position selected from the group consisting of: on top of the dashboard, under the dashboard, and inside the dashboard.

11. A sunshade device for a front passenger of an automobile; the automobile comprising a dashboard and a front passenger seat; the sunshade device comprising a sheet of material capable of blocking sunlight; wherein the sheet is mounted to the dashboard and extends towards the back support of the front passenger seat, blocking sunlight from shining on the general area of the front passenger seat.

12. The sunshade device of claim 11, wherein the sheet is made of material capable of blocking sunlight selected from the group consisting of cloth, paper, plastic, and rubber.

13. The sunshade device of claim 11, wherein the sheet can extend and retract from a housing mounted on the dashboard.

14. The sunshade device of claim 13, wherein the housing is mounted onto the dashboard at a vertical position selected from the group consisting of: on top of the dashboard, under the dashboard, and inside the dashboard.

15. The sunshade device of claim 11, wherein the angle of the sheet is adjustable.

16. The sunshade device of claim 11, wherein the length of the sheet is adjustable.

17. The sunshade device of claim 11, wherein the sunshade device is portable.

18. A method for shading a front passenger of an automobile from sunlight, wherein the automobile comprises a retractable shade mounted to the dashboard in front of the front passenger, the shade is in an initial retracted position; the steps of the method comprises:
extending the shade towards the body of the front passenger to block sunlight from the front passenger's body; and
retracting the shade towards the dashboard after use.

19. The method of claim 18, further comprising the step of adjusting the angle of the sheet after extending the shade.

20. The method of claim 18, further comprising the step of adjusting the length of the sheet after extending the shade.
